(19) United States
(12) Patent Application Publication
(10) Pub. No.: US 2026/0049899 A1
(43) Pub. Date: Feb. 19, 2026

(54) USAGE BASED MAINTENANCE SCHEDULING SYSTEM

(71) Applicant: RTX Corporation, Farmington, CT (US)

(72) Inventors: William D. Owen, Windsor, CT (US); Benjamin D. Hall, Glastonbury, CT (US); Emily Carolyn Roto Coleman, Worcester, MA (US); Cami Santor, Glastonbury, CT (US); Eric D. Kachel, Vernon, CT (US); Alex J. Brown, Vernon, CT (US)

(21) Appl. No.: 19/370,376

(22) Filed: Oct. 27, 2025

Related U.S. Application Data
(63) Continuation of application No. 17/464,837, filed on Sep. 2, 2021, now abandoned.
(60) Provisional application No. 63/227,392, filed on Jul. 30, 2021.

(51) Int. Cl. G01M 15/14; F02C 7/32; G06F 30/20; G06F 119/02

(52) U.S. Cl. CPC G01M 15/14; F02C 7/32; G06F 30/20; F05D 2220/323; G06F 2119/02

(57) ABSTRACT

A process for scheduling engine inspection for a gas turbine engine includes computing an expected damage increment based on aircraft usage data of a single flight, computing a cumulative expected damage by summing the expected damage increment with a total set of historical expected damage increments since a previous maintenance, and determining an aggregate risk of failure based on the computed cumulative expected damage. A manual inspection is signaled when the aggregate risk of failure exceeds an acceptable risk threshold.

### CROSS-REFERENCE TO RELATED APPLICATION

The application is a continuation of U.S. patent application Ser. No. 17/464,837 filed Sep. 2, 2021, which claims priority to U.S. Provisional Patent Application No. 63/227,392 filed on Jul. 30, 2021.

### TECHNICAL FIELD

The present disclosure relates generally to maintenance scheduling for aircraft engines, and more particularly to a scheduling system based on the actual usage of the aircraft engine.

### BACKGROUND

Traditional maintenance scheduling for aircraft engines includes a combination of life expectancy and observational scheduling, with the life expectancy scheduling being predetermined based on an expected use case and the structure of the component, and the observational being based on routine and periodic observation of specific components to identify damage.

Observational scheduling generally includes high frequency maintenance intended to prevent failure in components prone to Foreign Object Damage (FOD). Observational scheduling assumes a worst-case scenario of engine operation and FOD when defining inspection frequency and damage limits. Due to the worst-case scenario assumptions, observed FOD can lead to immediate unscheduled maintenance that may not be required to prevent component failure.

Predetermined, or life expectancy based, maintenance schedules are generally low frequency, primarily intended to prevent failure in components from damage incurred during an assumed engine operation, which may be conservative, e.g., aggressive use in harsh environments with more FOD assumed than experience might dictate.

In scheduling both life expectancy and observational based maintenance, assumptions are made in-terms of both the stress-state from vibration modes and stress increase due to FOD exposure and severity. These assumptions can result in increased fleet sustainment cost through unnecessary inspection and repair operations.

### SUMMARY OF THE INVENTION

In one exemplary embodiment a process for scheduling engine inspection for a gas turbine engine includes computing an expected damage increment based on aircraft usage data of a single flight, computing a cumulative expected damage by summing the expected damage increment with a total set of historical expected damage increments since a previous maintenance, determining an aggregate risk of failure based on the computed cumulative expected damage, and signaling a manual inspection in response to the aggregate risk of failure exceeding an acceptable risk threshold.

In another example of the above described process for scheduling engine inspection for a gas turbine engine the acceptable risk threshold is in the range of 1/100000 to 1/10000.

Another example of any of the above described processes for scheduling engine inspection for a gas turbine engine further includes resetting the total set of historical expected damage increments since a previous maintenance in response to a manual inspection occurring.

In another example of any of the above described processes for scheduling engine inspection for a gas turbine engine the aircraft usage data omits foreign object strike detection.

In another example of any of the above described processes for scheduling engine inspection for a gas turbine engine computing the expected damage increment comprises using a probabilistic foreign object damage model defined at least in part by previous inspection and usage data.

In another example of any of the above described processes for scheduling engine inspection for a gas turbine engine the probabilistic foreign object damage model is manually updated in response to new inspection and usage data.

In another example of any of the above described processes for scheduling engine inspection for a gas turbine engine the probabilistic foreign object damage model is at least partially dependent on a statistical data set.

In another example of any of the above described processes for scheduling engine inspection for a gas turbine engine the probabilistic foreign object damage model is automatically updated in response to new inspection and usage data.

In another example of any of the above described processes for scheduling engine inspection for a gas turbine engine resetting the total set of historical expected damage increments since a previous maintenance comprises setting the total set of historical expected damage increments to zero.

In another example of any of the above described processes for scheduling engine inspection for a gas turbine engine computing the expected damage increment comprises determining an expected damage increment at each mode of vibration that is excited in the engine, and summing the increment over all modes to determine the expected damage increment for a specific flight.

In another example of any of the above described processes for scheduling engine inspection for a gas turbine engine computing the expected damage increment comprises applying the aircraft usage data to a set of correlation models.

In another example of any of the above described processes for scheduling engine inspection for a gas turbine engine the set of correlation models includes at least a material capability model and a vibratory response characterization model.

Another example of any of the above described processes for scheduling engine inspection for a gas turbine engine further includes reiterating the process for each blade of at least one stage of the gas turbine engine.

In one exemplary embodiment a computer system for determining maintenance schedules for a gas turbine engine includes a foreign object damage module configured to determine an incremental foreign object damage based on data from an aircraft flight recorder, a data storage component configured to store historical incremental foreign object damage, a cumulative damage module configured to sum the determined incremental foreign object damage and the historical foreign object damage, and a risk determination module configured to determine an aggregate risk of foreign object damage based on the determined cumulative damage.

Another example of the above described computer system for determining maintenance schedules for a gas turbine engine further includes a connection for receiving a physical data transfer from an aircraft flight recorder.

Another example of any of the above described computer systems for determining maintenance schedules for a gas turbine engine further includes a wireless receiver configured to receive a wireless data transfer from an aircraft flight recorder.

In another example of any of the above described computer system for determining maintenance schedules for a gas turbine engine the foreign object damage module includes rate severity and location estimator configured to estimate at least one of a rate, severity and location of expected foreign object damage based on the data from the aircraft flight recorder.

In another example of any of the above described computer system for determining maintenance schedules for a gas turbine engine the foreign object damage module includes at least a material capability model and a vibratory response characterization model.

Another example of any of the above described computer system for determining maintenance schedules for a gas turbine engine further includes an output module configured to output an inspection required signal in response to a risk from the risk aggregation module exceeding a predefined threshold.

In another example of any of the above described computer system for determining maintenance schedules for a gas turbine engine the predefined threshold is in the range of 1/100000 to 1/10000.

These and other features of the present invention can be best understood from the following specification and drawings, the following of which is a brief description.

### BRIEF DESCRIPTION OF THE DRAWINGS

FIG. 1 schematically illustrates a gas turbine engine according to one example.

FIG. 2 illustrates a high level exemplary process for implementing a usage based maintenance scheduling system.

FIG. 3 illustrates an example operation of the process of FIG. 2 over time.

FIG. 4 schematically illustrates a flow model of a computer system for implementing the process of FIG. 1.

FIG. 5 illustrates an example fatigue assessment of the damage calculation.

FIG. 6 illustrates a cumulative damage over flights of an example aircraft.

FIG. 7 illustrates specific risk curves corresponding to the cumulative damages of FIG. 6.

FIG. 8 illustrates the aggregate risk curve of all of the risk curves of FIG. 7.

### DETAILED DESCRIPTION

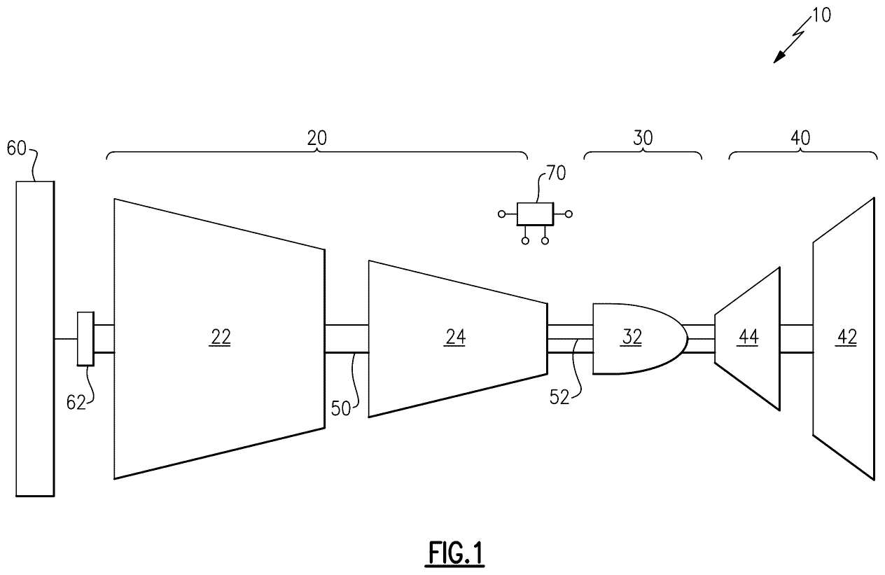

FIG. 1 illustrates an exemplary gas turbine engine 10, including a compressor section 20 connected to a combustor section 30 and a turbine section 40 via a first shaft 50 and a second shaft 52. The exemplary compressor section includes a low pressure compressor 22 fluidly connected to a high pressure compressor 24. An output of the high pressure compressor 24 is provided to at least one combustor 32 within the combustor section 30. The at least one combustor 32 mixes the output of the high pressure compressor 24 with a fuel and combusts the mixture. The resultant combustion products are provided to a high pressure turbine 44 along the flowpath. The high pressure turbine expands the combustion products which drives rotation of the high pressure turbine and the second shaft 52. Similarly, the output of the high pressure turbine 44 is provided to a low pressure turbine 42 and expanded. The expansion across the low pressure turbine 42 drives rotation of the low pressure turbine 42 and rotation of the first shaft 50. The second shaft 52 is connected to the high pressure compressor 24 and drives rotation of the high pressure compressor 24. Similarly, the first shaft 50 is connected to, and drives rotation of the low pressure compressor 22. A fan 60 is disposed upstream of the low pressure compressor 22 and is driven to rotate via a geared connection 62 to the first shaft 50. In alternate examples, the fan 60 can be connected via a direct drive, omitting the geared connection 62.

The gas turbine engine 10 described above, and illustrated in FIG. 1 is exemplary in nature, and it is appreciated that the following systems and processes can be applied similarly to any other aircraft engine, even when the other engine deviates substantially from the generally described construction. Due to the design and operating environment of the engine 10, certain components such as fan blades and compressor blades are subject to damage from debris and other ingested objects. The damage is referred to as foreign object damage (FOD).

During operation of the gas turbine engine 10, a data recorder 70 that is either local to the engine 10 (as in the example of FIG. 1), or within the aircraft and connected to sensors within the engine, stores flight operational data including, but not limited to rotor speed, time history, total engine flight hours, engine flight hours at maximum operating conditions, pressure and temperature at 1 or more engine station, aircraft altitude and mach number or forward velocity, crosswind speed, direction and any similar metrics. Flight operational data is at least partially determined via onboard sensors according to any known sensor configuration. Additional flight operational data can be inferred from one or more sensors according to known correlations and/or derived at least partially from engine control signals throughout the flight. After the flight, the data recorder is physically removed from the aircraft and provided to a computer system for analysis. In alternative examples, the aircraft can be physically connected to the computer system upon landing via a communication connection, or the data recorder can communicate wirelessly with the land-based computer system. In yet further alternative designs, a computer or controller onboard the aircraft can perform the process described below.

Rather than following a predefined time or flight hours-based maintenance and inspection schedule, the system described herein applies usage data from the flight data recorder to determine a probability of damage or risk of component failure (“risk”). Risk is then used to order maintenance as needed. This is referred to herein as “usage-based scheduling”. Usage-based scheduling offers reduced maintenance frequency by accounting for actual engine use to reduce or eliminate conservative assumptions that are necessary to define an observational or predetermined maintenance schedule.

FIG. 2 provides a general overview of the usage-based scheduling system for determining when manual inspections and maintenance are required to identify and repair foreign object damage for a given engine in a gas turbine engine, such as the engine 10 illustrated in FIG. 1. After each flight the aircraft data recorder is connected to a computer, and the flight data is provided to an analysis system in a “Provide Aircraft Usage Data” step 110.

The aircraft usage data includes engine metrics measured by conventional engine sensors, such as those described above. By way of example, one engine metric that can be used is rotor speed which infers exposure to vibrational modes which can also be correlated to various types of foreign object damage or debris ingestion events. The total stress state, defined by the combination of active vibrational modes and foreign object damage which acts as a stress riser, is determined throughout a time history. The stress time history is then used to calculate a damage increment. In practice, usage data is applied to a set of models to compute the expected damage increment for the specific flight in a “Compute Damage Increment” step 120. The expected damage increment is calculated using a probabilistic foreign object damage model at least partially dependent on and continuously calibrated to, statistical data sets of previous inspection and usage data and assuming that foreign object damage has occurred for each flight and at each potential foreign object damage zone of the component. In examples using vibrational modes to correlate with occurrences of foreign object damage and/or debris ingestion, the expected damage increment is calculated at each mode of vibration that is excited in the engine by measuring or computing the time history of the response. In some examples, the foreign object damage model is an engineering model.

The damage is summed for contributing modes of vibration to determine the damage increment for the specific flight. In some examples, after a certain number of iterations, the engineering model for foreign object damage is manually revised based on empirical results in the field to account for new inspection and usage data. This update can be performed manually, automatically, or both, depending on the type of inspection and usage data acquired.

Once the expected damage increment has been calculated, the system applies the increment to the damage history of the engine in a “Compute Cumulative Damage” step 130. The cumulative damage represents the total deterioration over time of the engine components since the previous maintenance. In a practical example there are a large number of cumulative damage values that are independently tracked, and the complexity resulting from the amount of tracked values would take longer to calculate manually than there is time between flights and the process could not be practicably achieved without computer assistance.

After determining the cumulative damage values, the probability of failure of the components in a subsequent flight is determined in a “Compute Probability of Failure” step 140. The probability of failure is calculated for each possible foreign object damage location from each flight that has occurred since the previous maintenance. This process is repeated for each airfoil or airfoil type separately, and in the aggregate, as well as for any other components that are susceptible to foreign object damage. By way of example, if any components, such as blades include unique information or attributes, each of the components that have unique information is analyzed independently to account for the special information. Alternatively, when an assembly such as a bladed wheel includes, as a whole, a defining feature such as intentional mistuning, the components of the assembly driving the defining feature are analyzed in the aggregate.

When the probability of failure on the next flight (alternately referred to as “risk”) exceeds a predefined threshold, the system 100 outputs an inspection requirement in an “Output Inspection Requirement” step 150. In one example, the risk threshold is in the range of 1/100000 to 1/10000, although specific implementations may stray from that range depending on the particular usage of the engine and aircraft in question, as well as the applicable industry or internal standards. When the probability of failure is below the risk threshold an inspection is not ordered, and the process is reiterated after the next flight.

When an inspection is ordered, manual inspection and maintenance is performed on the aircraft during which any damage, including foreign object damage, is manually identified and repaired by one or more technician in a “Perform Maintenance” step 160. Once any identified damage is repaired, or the corresponding components are replaced, the historical record of damage data is reset to 0 in a “Reset” step 170, and the process 100 reiterates with the next flight.

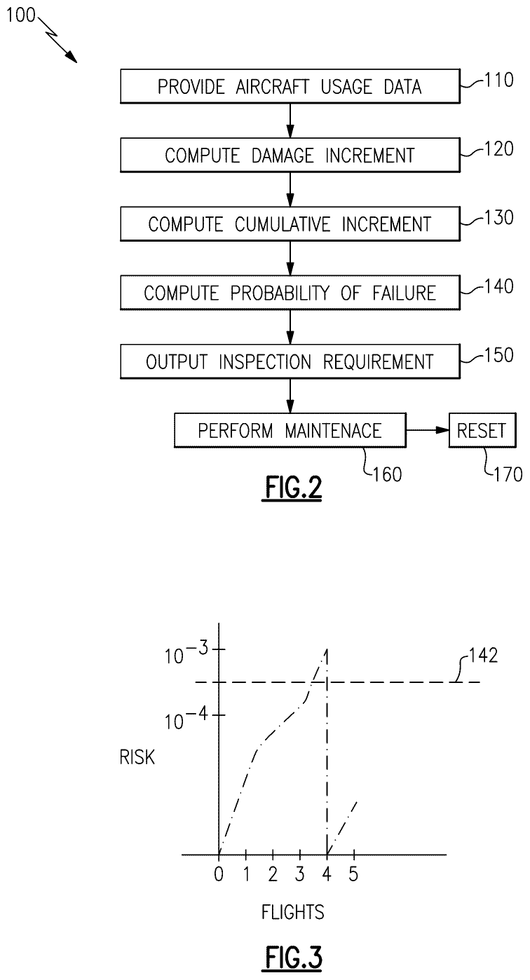

With continued reference to the process 100 of FIG. 2, FIG. 3 illustrates an example cycle over 5 sequential flights. After each flight, the cumulative risk (RISK) increases until the fourth flight, where the cumulative risk exceeds the predefined threshold 142. After the fourth flight, the computer system operating the process orders an inspection and maintenance is performed. In one example, the computer system assumes 100% effective inspection and maintenance and causes the cumulative risk to be reset to no cumulative risk prior the fifth flight. In other examples, the reset can account for “imperfect” maintenance by resetting to a cumulative damage value above zero. In yet further examples, the system can wait for a confirmation that the maintenance operation was successful before resetting the cumulative risk. As each damage increment is dependent on the total aircraft usage data from the corresponding flight, the number of flights or the number of flight hours between maintenance is not uniform, and the occurrence of costly and time-consuming manual inspections and maintenance is limited to times when the risk of foreign object damage exceeds an acceptable level.

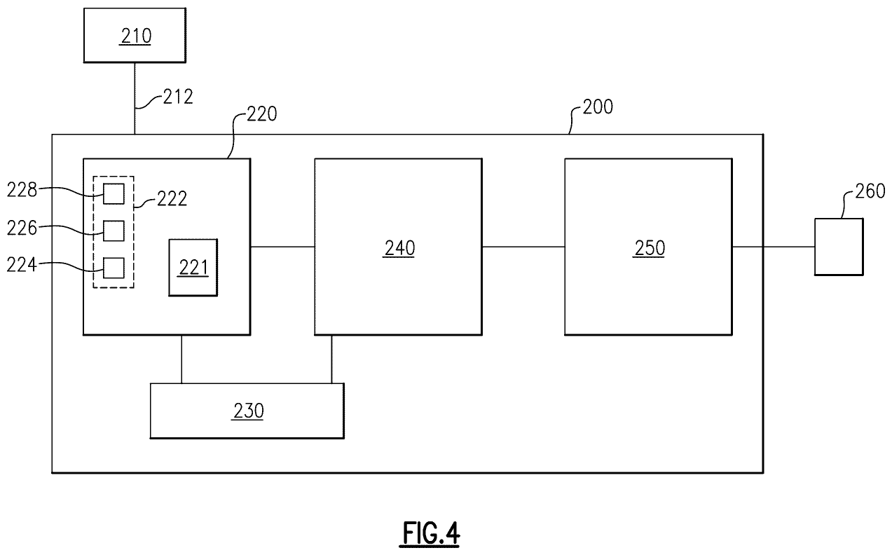

With continued reference to FIGS. 1-3, FIG. 4 schematically illustrates an exemplary model computer system 200 for implementing the process 100 of FIG. 1 including both physical components and software modules. The computer system 200 includes a flight data recorder 210 connected to the computer system 200 either via a physical data transfer connection 212 or via a wireless, or similar, data transfer connection. The aircraft usage data is provided to foreign object damage module 220 that computes the damage increment from the given flight based on the aircraft usage data, and a set of correlation models 222 including a material capability model 224, a vibratory response characterization model 226, and any other models 228 able to determine expected magnitudes of foreign object damage based on the aircraft usage data. Also included in the foreign object damage module 220 is a rate, severity, and location assessment module 221 that uses the models 222 to determine the expected rate, severity, and location of foreign object damage. In some examples, the models 222 are combined with inlet debris monitoring system readings and the exhaust distress monitoring systems data from the aircraft usage data to determine the expected rate severity, and location of foreign object damage.

Summed foreign object damage across all contributing modes of vibration that are generated by the foreign object damage module 220 is stored within a data storage component 230 during each iteration, creating a set of historical damage calculations. The data storage component 230 can be any form of data storage, and can be located internal to the computer system 200, internal to the flight data recorder 210 storing the aircraft usage data, or external to both systems.

In addition to the data storage element 230, the incremental damage that is calculated is passed to a cumulative damage module 240. The cumulative damage module 240 retrieves the stored historical damage increments from the data storage element 230 and generates the total cumulative damage, which is then provided to a risk calculation module 250. The risk calculation module 250 determines the probability of failure based on the total cumulative damage, as described above, and compares the probability of failure to the acceptable risk. When the probability exceeds the acceptable risk, the computer system provides an alert at an output system 260 that informs the technician that a manual inspection is required.

To determine the damage increment based on the material capability of the blades, a fatigue damage accumulation rule, such as Miner's Rule, is applied at each time point of a predetermined frequency and the time points are summed for each mode. In the Miner's rule example, the damage at a given time point i is defined as:

$${ϵ}_{i} = \frac{cycles}{cycles to failure} .$$

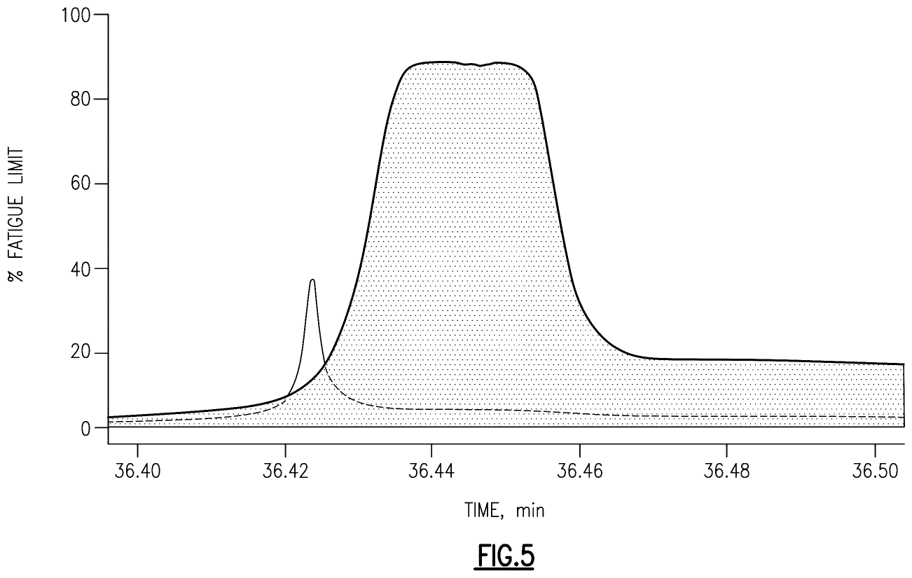

The material capability model determines “cycles to failure” using a stress-life modeling system. In other examples, alternative modeling systems can be utilized to similar effect. Most time points have negligible damage levels of zero or approximately zero, however every time point is summed regardless of whether the damage level is approximately zero or is substantial. FIG. 5 illustrates the damage increments for one zone at two modes of vibration according to an exemplary Goodman analysis model. As can be seen the illustrated two modes include spikes, or plateaus, where the damage levels are meaningful but are still primarily filled with de minimus damage levels.

In addition to Goodman modeling, a standard stress-life model defines the distribution for cycles to failure at all stress levels. Standard stress-life models are used to relate the logarithm of life to stress or the logarithm of stress. Similarly, scatter in life is quantified using standard distributions such as the lognormal, Weibull, or smallest extreme value. Model forms, as well as specific values for numeric constants are determined from specimen and/or component fatigue testing.

With continued reference to FIGS. 1-4, FIGS. 6-8 illustrate an exemplary process for determining an aggregate risk (FIG. 8) based on the cumulative damage (FIG. 6). For the sake of explanation, in the example of FIG. 6, each flight produces the same damage increment (i.e., 0.05), with the set of lines in FIG. 6 corresponding to a first FOD occurring on flight 1 (D_{1,j,1}), a first FOD occurs on flight 2 (D_{2,j,1}), . . . , and a first FOD occurs on flight 26 (D_{26,j,1}). Each cumulative damage sum line from FIG. 6 has an associated conditional probability of failure curve. In a practical example, the increment will not be identical between flights.

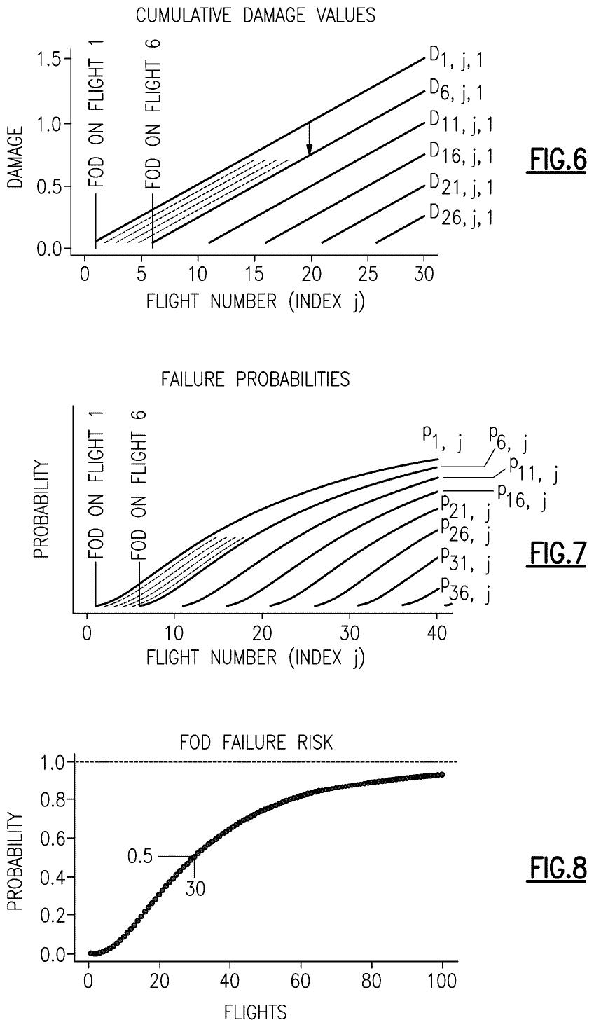

FIG. 7 illustrates the conditional probabilities of failure based on the first FOD occurring on flight 1 (p_{1,j}), the first FOD occurring on flight 2 (p_{2,j}), . . . and the first FOD occurring on flight 26 (p_{26,j}). As can be seen, each curve asymptotically approaches 1, as the failure is an eventual certainty. As the process is performed without determining or sensing actual foreign object damage occurrences it is unknown when, or if, the foreign object damage occurs. Thus, the risk curves across all 26 flights from FIG. 7 are aggregated into a single risk curve, illustrated in FIG. 8. The risk is aggregated using the standard rules of probability: Total Risk at Flight j=Prob(HCF@Flight j|FOD on 1)×Prob(FOD on 1)+Prob(HCF@Flight j|FOD on 2)×Prob(FOD on 2)+ · · · +Prob(HCF@Flight j|FOD on j)×Prob(FOD on j).

The aggregated risk is the value that is compared with the acceptable risk to determine whether an inspection and maintenance is required after each flight.

By using the above described process and system, the usage based maintenance scheduling reduces maintenance cost and increase fleet readiness by replacing traditional schedule based inspection with the above described process that predicts the need for inspection based on engine usage.

It is further understood that any of the above described concepts can be used alone or in combination with any or all of the other above described concepts. Although an embodiment of this invention has been disclosed, a worker of ordinary skill in this art would recognize that certain modifications would come within the scope of this invention. For that reason, the following claims should be studied to determine the true scope and content of this invention.

1-20. (canceled)

21. A computer system for determining maintenance schedules for a gas turbine engine comprising:
an aircraft flight recorder configured to record flight operational data of a single flight of a gas turbine engine from one or more sensors;
a foreign object damage module configured to determine an expected incremental foreign object damage of the gas turbine engine based on the flight operational data of the single flight;
a data storage component configured to store historical expected incremental foreign object damage for the gas turbine engine;
a cumulative damage module configured to sum the determined expected incremental foreign object damage and the historical expected foreign object damage since a last maintenance of the gas turbine engine;
a risk determination module configured to determine an aggregate risk of foreign object damage of the gas turbine engine based on the determined cumulative expected damage; and
an output module configured to output an inspection required signal in response to a risk from the risk aggregation module exceeding a predefined threshold.

22. The computer system of claim 21, further comprising a connection for receiving a physical data transfer from an aircraft flight recorder.

23. The computer system of claim 21, further comprising a wireless receiver configured to receive a wireless data transfer from an aircraft flight recorder.

24. The computer system of claim 21, wherein the foreign object damage module includes rate severity and location estimator configured to estimate at least one of a rate, severity and location of expected foreign object damage based on the data from the aircraft flight recorder.

25. The computer system of claim 21, wherein the foreign object damage module includes at least a material capability model and a vibratory response characterization model.

26. The computer system of claim 21, wherein the predefined threshold is in the range of 1/100000 to 1/10000.

27. The computer system of claim 21, wherein the computer system is configured to reset the total set of historical expected incremental foreign object damage since a previous maintenance of the gas turbine engine in response to a manual inspection of the gas turbine engine occurring.

28. The computer system of claim 21, wherein to compute the expected incremental foreign object damage, the computer system is configured to determine an expected incremental foreign object damage at each mode of vibration that is excited in the engine, and sum the expected incremental foreign object damage over all modes to determine the expected foreign object damage increment for a specific flight.
